(19) United States
(12) Patent Application Publication
(10) Pub. No.: US 2003/0131707 A1
(43) Pub. Date: Jul. 17, 2003

(54) Cutting device and cutting method

(76) Inventors: Mikio Yotsumoto, Ibaraki (JP); Yutaka Matsuda, Takarazuka (JP)

Correspondence Address: MERCHANT & GOULD PC, P.O. BOX 2903, MINNEAPOLIS, MN, 55402-0903, US

(21) Appl. No.: 10/203,864

(22) PCT Filed: Jul. 6, 2001
(86) PCT No.: PCT/JP01/05924

(51) Int. Cl. B26D 3/00; B26D 5/08; B26D 11/00; B31B 1/25; B26D 3/08

(52) U.S. Cl. 83/862; 83/52; 83/596; 83/886

(57) ABSTRACT

First and second rotating units (110, 120) include a pair of rotors (111, 121) opposing each other, a spindle (113, 123) provided between the pair of rotors, and an impacting body (130, 140) mounted rotatably on the spindle (113, 123). The impacting body (130, 140) is mounted so that a predetermined fitting gap is provided between the impacting body and the spindle and a part of a periphery of the impacting body can be positioned beyond a periphery of the rotor. The impacting bodies of the first and second rotating units impact on an object to be processed sequentially while the rotating units are rotated at a high speed, thereby cutting the object to be processed. A cutting depth by the impacting body of the second rotating unit is larger than that by the impacting body of the first rotating unit, and the impacting body of at least one of the rotating units impacts on the object to be processed at least at a critical impact velocity. This makes it possible to cut an object to be processed formed of a single material or a composite material using a single cutting tool and to extend the lifetime of a cutting device and improve the reliability thereof.

### TECHNICAL FIELD

The present invention relates to a cutting device and a cutting method that can cut an object formed of a single material, such as glass, ceramics, resin, metal, or the like, or a composite material thereof continuously using one kind of cutting tool. More particularly, the present invention relates to a cutting device and a cutting method that cut an object while smashing the very surface portion of the object that is subjected to an impact by allowing an impacting body formed of a hard solid body to impact on the object at a high speed with a high frequency.

### BACKGROUND ART

Generally, methods used for cutting and disassembling glass used in a cathode-ray tube (CRT) (hereinafter, referred to as “CRT glass”) for the purpose of its recycling include a method of utilizing the thermal shock obtained by winding a heater wire around the CRT and energizing the heater wire to heat the CRT, a cutting method of using a diamond wheel cutter that is rotated at a high speed, a gas cutting method (a method of melting and cutting glass using a gas), or the like.

Generally, sheet steel pieces (cold-rolled steel sheets or the like) forming bodies of automobiles and case bodies or other components of various household electric appliances are cut by a band-shaped cutter (a band saw machine) or a disc-shaped cutter (a metal slitting saw), which is provided with a high hardness saw blade, by grinder cutting using a grinding tool in which abrasive grains are formed in a disc shape or in a cylindrical shape, or by gas cutting using an acetylene torch or the like.

Generally, resin-molded articles are cut by a band saw machine, a metal slitting saw, an end mill, or the like.

In this connection, no cutting device that can cut a member containing different materials such as glass of the CRT or the like, sheet steel, or resin-molded articles continuously one after another by rotating one kind of tool (a tool provided with a cutting blade) or by moving it at a high speed has been proposed.

However, in the respective conventional cutting methods described above, there have been the following problems.

(1) In cutting the CRT glass as described above, due to the differences in shape, size, manufacturing processes, or the like of the CRT, the residual stress in the glass varies. Therefore, in the method of energizing and heating a heater wire in which the thermal shock is utilized, it is difficult to determine stable cutting and heating conditions or to form a certain stable cut surface.

In the cutting method using a diamond wheel cutter, when the cutting speed is increased, the wear rate of the diamond wheel cutter increases due to frictional heat and therefore the cutting speed is limited. In addition, the diamond wheel cutter is expensive and the cutting amount and the wear rate of the diamond wheel have a close relationship, resulting in a high cutting cost.

Furthermore, in the gas cutting method using a hot gas, the cutting speed is slow and this method is dangerous when combustible materials are present near an object to be cut or a section to be cut. Thus, the applicability of this method is limited.

(2) When the sheet steels pieces are cut using a tool such as a band saw machine or a metal slitting saw, a cutting blade of the tool is pressed strongly against an object to be cut to cause a continuous shear fracture in the object to be cut, thus cutting and processing the object to be cut.

Since the cutting blade is pressed strongly against the object to be cut, frictional heat is generated greatly at the cutting part. Therefore, the embrittlement and enfeeblement of its cutting edge due to the heat aggravate the abrasion of the cutting edge.

Due to the abrasion of the cutting blade, the cutting speed lowers considerably and thus is limited. In addition, since the cutting blade is allowed to bite into the object to be cut, a high stiffness is needed for holding the tool (a cutter) and the object to be cut, thus requiring a large scale holding mechanism and a high installation cost.

The grinder cutting using a grindstone is carried out by causing continuous small shears by cutting blades of the abrasive grains. Since the corners (cutting blades) of the abrasive grains are not so sharp and the peripheral speed of the grinder is relatively high, the frictional heat generated at the cutting part is great. In order to secure the lifetime of the grindstone, it is necessary to control the temperature of the cutting part appropriately. Thus, the cutting speed is limited.

In the gas cutting using a gas such as acetylene, it is important in view of safety that no combustibles be present in the vicinity of the cutting section. Therefore, the applicability of the gas cutting is limited.

(3) In the case of using a band saw machine, a metal slitting saw, or the like for cutting resin-molded articles, when the cutting speed is raised, the vicinity of the cutting part of an object to be cut starts burning or melts due to the frictional heat generated by the friction with the tool, thus causing a change in the physical properties of the object.

(4) When a blade made of a material containing a ferroalloy as a main constituent is used in cutting a metallic magnetic component, the fragments and powder that are produced by cutting an object to be cut are magnetic substances and thus adhere to the edge of the blade. Consequently, the increase in frictional resistance or the damage of the edge lowers the cutting performance of the blade considerably.

(5) It is extremely difficult to cut an object formed of a plurality of members with different physical properties (for example, metal, resin-molded articles, glass, ferrite, or the like) continuously using the same tool.

(6) When the information required for cutting and processing (physical properties or the like) an object is unknown or when an object to be cut is formed of a plurality of members and the shapes and materials of the members hiding behind the surface member are unknown, optimal cutting conditions cannot be determined merely from the image information of the surface and outer shape of the object to be cut. Therefore, the automatic control for optimal cutting is impossible.

### DISCLOSURE OF INVENTION

It is an object of the present invention to solve the above-described problems of various conventional cutting methods and to provide a cutting device and a cutting method that can cut an object to be processed formed of a single material, such as glass, ceramics, resin, metal, or the like, or a composite material thereof using one kind of cutting tool. It is a further object of the present invention to provide a cutting device with improved lifetime and reliability.

In order to achieve the above-mentioned objects, the present invention puts a theory into practical use as a cutting device and a cutting method. The theory is a plastic wave theory in which when a high-speed tensile force is applied at least at a critical impact velocity, a fracture occurs immediately at the part where the force has been applied, or a theory in which when a high-speed compressive force is applied at least at a critical impact velocity, the ductility is deteriorated rapidly and thus the part where the force has been applied is broken even by a small distortion (a phenomenon similar to the embrittlement).

Particularly, a cutting device according to the present invention replaces a conventional tool provided with a blade, and in the cutting device an impacting body formed of a hard solid body such as metal is allowed to impact on an object to be cut (hereinafter referred to as “an object to be processed” or “a workpiece”) at a very high speed with a high frequency to generate a plastic wave by the impact energy, thus breaking and removing the part subjected to the impact instantaneously.

In other words, the cutting device and the cutting method of the present invention are based on the following principle: when an impacting body that executes a high speed circular motion impacts on a workpiece at least at the critical impact velocity of the workpiece and then bounces (rebounds), the surface of the workpiece in a highly limited portion including the part subjected to the impact by the impacting body and its vicinity is smashed (broken) instantaneously into a minute granular state or minute fragments by a high speed compression that occurs together with impact, a high speed tension due to friction, high speed shearing, or the like.

Generally, in processing a workpiece, external forces such as a tensile force, a compressive force, or a shearing force are applied to the workpiece by the movement of a tool and thus the workpiece is distorted or deformed. In this case, when the speed of the tool, i.e. the processing speed, is increased gradually and reaches a certain limitation, the ductility of the workpiece deteriorates rapidly. This limitation speed is called the critical impact velocity. In the workpiece, the part subjected to the force applied by a tool is broken immediately when the processing speed is increased to the critical impact velocity or more. When utilizing this, by allowing an impacting body to impact on the workpiece at least at the critical impact velocity, only the very surface portion of the workpiece that is subjected to the impact by the impacting body can be broken and removed. By setting an extremely large number of impacts by the impacting body per unit time, this phenomenon can be created repeatedly. Furthermore, by successively changing the position at which the impacting body impacts, only the part on which the impacting body impacts can be removed and processed successively without breaking the portion other than the part in the workpiece. Macroscopically, this can be considered as cutting and processing of the workpiece. According to this cutting method, a relatively smooth cut surface can be obtained.

In order to generate a plastic wave, the impacting body has to impact on a workpiece at least at the critical impact velocity of the workpiece. More specifically, in general, the impact velocity preferably is set to be at least about 139 m/second (about 500 km/hour), more preferably at least about 340 m/second (about 1224 km/hour).

When converted to the peripheral speed of a disc with a diameter of 100 mm, the above-mentioned impact velocities correspond to rotational speeds of at least 26,500 rpm and of at least 65,130 rpm, respectively.

In practice, the critical impact velocity varies depending on the kind of a workpiece. For instance, the critical impact velocities of aluminum, soft steel, stainless steel, and titanium are about 49.7 m/second, 30.0 m/second, 152.3 m/second, and 61.8 m/second, respectively. Therefore, the impact velocity of the impacting body can be changed according to the kind of workpiece. The impact velocity of the impacting body preferably is set to be at least twice, further preferably at least three times, and particularly preferably at least four times as high as the critical impact velocity of the workpiece, because this allows stable cutting.

The impacting body has a through hole and is maintained rotatably by a spindle provided perpendicularly on a rotor with a predetermined fitting gap being provided between the impacting body and the spindle. By providing the fitting gap, it is possible to absorb the displacement of the impacting body that occurs right after the impacting body has impacted on a workpiece. Preferably, the fitting gap between the spindle for supporting the impacting body and the through hole of the impacting body is set to be at least 2 mm, more preferably about 5 to 10 mm. It is preferable that the fitting gap is designed to be larger along with an increase in impact velocity of the impacting body. The fitting gap according to the present invention is far beyond the gap value according to the Japanese Industrial Standard (JIS), which generally defines the fitting state between an axis and a bearing, and is two to three orders of magnitude larger than the gap value.

As described above, the processing principle of the present invention is different from a conventional processing principle by utilizing impact. In the conventional processing principle, a cutting blade of a cutting tool is allowed to collide with a workpiece at a low speed (a maximum of about 10 m/second) and the workpiece is deformed in a sequence from elastic deformation through plastic deformation to breakage, thus breaking the surface of the workpiece in a relatively large area.

The impacting body of the present invention is not provided with a sharp cutting blade as in the conventional cutting tool.

The cutting according to the present invention based on the above-mentioned principle is characterized as follows.

(1) According to the smashing (cutting) principle utilizing the high speed compression and high speed tension at least at a critical impact velocity when the impacting body impacts on a workpiece, an extremely small amount of the frictional heat is generated only at the part to be cut in the workpiece. In addition, the impacting body is air-cooled rapidly by its quick movement and thus the increase in temperature of the impacting body itself also is extremely small.

(2) A conventional cutting tool that executes a rotational motion, a reciprocating motion, or a rectilinear motion is heavily worn away. On the other hand, the impacting body of the present invention is subjected to the work hardening by the impact on a workpiece and therefore is hardened as it is used, thus increasing its abrasion resistance.

(3) In the processing principle of the present invention, the cutting resistance and the frictional resistance are low. As a result, a workpiece does not have to be held and fixed firmly during cutting. In addition, it is not necessary to provide a high stiffness for a spindle for supporting the impacting body, a rotor that rotates at a high speed, a main shaft, a bearing and a robot for holding the main shaft of the rotor.

(4) By mounting an oscillation detector for detecting an intrinsic oscillatory wave form (or an intrinsic oscillation frequency), which is generated by a rotor depending on the nature of the workpiece when cutting the workpiece, on a multi-axis control robot, processing conditions (the impact velocity of the impacting body, the moving speed, etc.) can be controlled depending on the workpiece to be processed.

(5) Even when a workpiece is formed of a plurality of different members (for example, metal, a resin-molded article, glass or ferrite (iron based material)) and the inside of the workpiece cannot be seen from the outside, the workpiece can be cut continuously using the same cutting device.

As described above, the cutting device of the present invention has a simple configuration and can achieve an extended lifetime and a considerably improved reliability. In addition, since it is not necessary to take into consideration during the cutting process that different materials may be intermixed in a workpiece, the cutting device of the present invention is extremely useful as a smashing or cutting device that is a part of recycling equipment.

Therefore, the present invention can automate disassembling and cutting processes of household electric appliances, automobiles, or the like for the purpose of disposal, and eliminates the need for changing the type of cutting tool, processing conditions, or a cutting device according to the kind of an object to be processed or members included in the object. In addition, the present invention contributes to the improvement in reliability, the extension of lifetime of the cutting device and the increase in recycling ratio, the environmental protection, and the efficient use of natural resources.

A specific configuration of a cutting device according to the present invention is described in the following.

A cutting device of the present invention includes at least a first rotating unit and a second rotating unit. Each of these rotating units includes a rotor with a principal plane, a spindle provided in a normal direction to the principal plane, and at least one impacting body mounted on the spindle rotatably. The impacting body is mounted so that a predetermined fitting gap is provided between the impacting body and the spindle and a part of a periphery of the impacting body can be positioned beyond a periphery of the rotor. The impacting body of the first rotating unit and the impacting body of the second rotating unit impact on an object to be processed sequentially while the rotating units are rotated in a plane parallel with the principal plane of the rotor at a high speed and the first and second rotating units are held so that a circular path of a tip (a cutting blade) of the impacting body of the first rotating unit and a circular path of a tip (a cutting blade) of the impacting body of the second rotating unit during the rotation substantially are on the same plane, thereby cutting the object to be processed in a direction substantially parallel with the principal plane of the rotor. A cutting depth by the impacting body of the second rotating unit is larger than that by the impacting body of the first rotating unit, and the impacting body of at least one of the rotating units impacts on the object to be processed at least at a critical impact velocity. Here, the “critical impact velocity” refers to an intrinsic physical property value of an object to be processed and, when the object to be processed is a composite material of a plurality of materials with different critical impact velocities, means the largest critical impact velocity among them.

In accordance with the above-described cutting device, while rotating at least two rotating units, the impacting bodies thereof are allowed to impact on a workpiece by sequentially increasing the cutting depths by the impacting bodies. At this time, the impacting body of at least one of the rotating units is allowed to impact at least at the critical impact velocity of the workpiece. Such an impact cutting utilizing a centrifugal force can reduce abrasion of the impacting body serving as a cutting blade, thereby extending a lifetime of the cutting device and improving its reliability. Furthermore, a high speed smashing or a high speed cutting can be achieved regardless of the kind of the object to be processed.

Moreover, by allowing the impacting body to impact on the workpiece such that the cutting depths of a plurality of the rotating units increase sequentially, a stable and excellent cutting performance can be achieved with respect to a thick workpiece or a workpiece formed by layering in a thickness direction a plurality of members with different physical properties.

The above-described cutting device can be designed such that the impacting body of the first rotating unit, which impacts on the object to be processed first, impacts on the object to be processed at least at the critical impact velocity. When a top layer of the workpiece is formed of a hard material (a difficult-to-machine material) such as metal and a relatively soft material such as resin is layered on its back side, for example, only the difficult-to-machine material layer as the top layer is cut by the first rotating unit, and the soft layer below is then cut by the second rotating unit. At this time, by allowing the impacting body of the first rotating unit to impact at least at the critical impact velocity of the difficult-to-machine material layer as the top layer, the difficult-to-machine material layer can be cut by a processing principle of the present invention described above. In this manner, with respect to the workpiece formed by layering different kinds of materials, the rotational speed of each rotating unit is set according to physical properties (the critical impact velocity) of each layer, thereby allowing the impacting body to impact on the workpiece in which different kinds of materials are layered, so that an efficient and stable cutting can be achieved. In the above example, it is preferable that the impacting body of the second rotating unit, which cuts the soft layer below, also is allowed to impact at least at the critical impact velocity of this soft layer, but there are some cases where, depending on the material of the soft layer, the soft layer can be cut excellently even when allowing the impacting body to impact at the critical impact velocity or lower.

Also, in the above-described cutting device, the rotating units can be provided on a common base. This makes it possible to configure a compact cutting device. Also, it becomes easier to control the position of each rotating unit.

Furthermore, in the above-described cutting device, an outer shape of the impacting body can be any one of a polygon with a plurality of corners, a shape with projections at substantially equal angles on its periphery, a disc shape, a substantially-bell shape, a substantially-“9” shape and a substantially-bow shape. The shape of the impacting body is selected according to the impact velocity of the impacting body, a cutting depth and a material of the workpiece serving as an object to be cut, thereby achieving an efficient cutting device.

Moreover, in the above-described cutting device, the impacting body can be made to have a different shape for each of the rotating units. For example, an optimal shape of the impacting body is selected according to a rotational speed of the rotating unit, a radius of gyration of the impacting body or a cutting depth thereof, thereby balancing a cutting performance, cost and an installation safety in an excellent manner.

Also, in the above-described cutting device, it is preferable that the fitting gap between the spindle and the impacting body is at least 2 mm, and it is particularly preferable that the fitting gap is 5 to 10 mm. When the fitting gap is smaller than the above range, the displacement of the impacting body caused by the rebound after the impacting body has impacted on the workpiece cannot be absorbed excellently, lowering a cutting performance. On the other hand, when the fitting gap is too large, the effect of improving the cutting performance cannot be obtained, or rather the cutting performance deteriorates because the position of the impacting body is unstable or the adjacent impacting bodies collide with each other.

Moreover, in the above-described cutting device, it is preferable that the impacting body of at least one of the rotating units impacts on the object to be processed at a speed of at least about 139 m/second (about 500 km/hour), and it is particularly preferable that the impacting body of at least one of the rotating units is allowed to impact at a speed of at least about 340 m/second (about 1224 km/hour). It also is preferable that the impacting body is allowed to impact on the object to be processed at a frequency of at least about 150 times/min. This allows a high-speed cutting regardless of a material and a kind of the object to be processed.

Furthermore, in the above-described cutting device, it is preferable that the impacting body of at least one of the rotating units impacts on the object to be processed at a speed at least twice as high as the critical impact velocity of the object to be processed. This allows a high-speed cutting regardless of a material and a kind of the object to be processed.

In addition, the above-described cutting device can be mounted to an arm of a robot with a multi-axis control function. This allows three-dimensional processing (processing of a curved surface).

Also, in the above-described cutting device, at least one of an intrinsic oscillatory waveform and an intrinsic oscillation frequency that are caused by an impact of the impacting body against the object to be processed, a load on a driving motor for rotating each of the rotating units and an outer shape of the object to be processed can be detected, and at least one of a rotational speed of the rotating units, a cutting depth and a relative speed and a relative moving direction between the rotating units and the object to be processed can be changed. This makes it possible to set optimal cutting conditions automatically even when the material of the object to be processed is unknown, allowing an automation of the cutting.

In the above, it is preferable that at least one of the intrinsic oscillatory waveform, the intrinsic oscillation frequency and the load on the driving motor is detected for each of the rotating units, and at least one of the rotational speed of the rotating units, the cutting depth and the relative speed and the relative moving direction between the rotating units and the object to be processed is changed for each of the rotating units. This makes it possible to set optimal cutting conditions automatically for each of the rotating units, allowing for efficient cutting.

Next, a cutting method of the present invention includes using at least a first rotating unit and a second rotating unit, each of these rotating units including a rotor with a principal plane, a spindle provided in a normal direction to the principal plane, and at least one impacting body mounted on the spindle rotatably, and allowing the impacting body of the first rotating unit and the impacting body of the second rotating unit to impact on an object to be processed sequentially while the rotating units are rotated in a plane parallel with the principal plane of the rotor at a high speed and the first and second rotating units are held so that a circular path of a tip (a cutting blade) of the impacting body of the first rotating unit and a circular path of a tip (a cutting blade) of the impacting body of the second rotating unit during the rotation substantially are on the same plane, thereby cutting the object to be processed in a direction substantially parallel with the principal plane of the rotor. The impacting body of each of the rotating units is mounted so that a predetermined fitting gap is provided between the impacting body and the spindle and a part of a periphery of the impacting body can be positioned beyond a periphery of the rotor. A cutting depth by the impacting body of the second rotating unit is made larger than that by the impacting body of the first rotating unit. The impacting body of at least one of the rotating units is allowed to impact on the object to be processed at least at a critical impact velocity. Here, the “critical impact velocity” refers to an intrinsic physical property value of an object to be processed and, when the object to be processed is a composite material of a plurality of materials with different critical impact velocities, means the largest critical impact velocity among them.

In accordance with the above-described cutting method, while rotating at least two rotating units, the impacting bodies thereof are allowed to impact on the workpiece by sequentially increasing the cutting depths by the impacting bodies. At this time, the impacting body of at least one of the rotating units is allowed to impact at least at the critical impact velocity of the workpiece. Such an impact cutting utilizing a centrifugal force can reduce abrasion of the impacting body serving as a cutting blade, thereby extending a lifetime of the cutting device and improving its reliability. Furthermore, a high speed smashing or a high speed cutting can be achieved regardless of the kind of the object to be processed.

Moreover, by allowing the impacting body to impact on the workpiece such that the cutting depths of a plurality of the rotating units increase sequentially, a stable and excellent cutting performance can be achieved with respect to a thick workpiece or a workpiece formed by layering in a thickness direction a plurality of members with different physical properties.

In the above-described method, it is preferable that, when the object to be processed is formed by layering at least a first layer and a second layer that have different critical impact velocities, the first layer is cut mainly by the impacting body of the first rotating unit, the second layer is cut mainly by the impacting body of the second rotating unit, and an impact velocity of the impacting body of the first rotating unit against the object to be processed is made different from that of the impacting body of the second rotating unit against the object to be processed. In other words, when cutting an object to be processed that is formed by layering a plurality of layers with different critical impact velocities, the cutting depths of the impacting bodies of the rotating units are adjusted, thus cutting different layers with different rotating units. This makes it possible to set optimally the impact velocities of the impacting bodies of the rotating units according to the respective critical impact velocity of the layer they cut. As a result, an efficient cutting becomes possible. In addition, an unnecessary high-speed rotation of the rotating unit can be avoided, and an excessive installation design and a wasteful energy consumption can be suppressed.

Furthermore, in the above-described cutting method, when the object to be processed is formed by layering at least a first layer and a second layer that has a critical impact velocity smaller than the first layer, it is preferable that the first layer first is cut mainly by the impacting body of the first rotating unit, and then the second layer is cut mainly by the impacting body of the second rotating unit. In other words, when cutting an object to be processed that is formed by layering layers with different critical impact velocities, the first layer with a larger critical impact velocity is cut first using the first rotating unit, and then the second layer with a smaller critical impact velocity is cut using the second rotating unit. In general, it is preferable to increase the impact velocity of the impacting body as the critical impact velocity of a material to be cut becomes larger. However, in order to increase the impact velocity of the impacting body, the rotating unit has to be rotated at a high speed, which generates a larger centrifugal force. This brings about the need for a weight reduction for suppressing the generation of centrifugal force or the need for a reinforcement of the impacting body. On the other hand, a smaller cutting depth allows a miniaturization of the impacting body, making it possible to reduce weight, which can suppress the generation of the centrifugal force. Thus, by cutting the first layer with a larger critical impact velocity first, it becomes possible both to secure the necessary impact velocity of the impacting body and to reduce the centrifugal force that is generated.

In this case, it is preferable that the cutting depth by the impacting body of the first rotating unit is equal to or larger than a thickness of the first layer. This allows the first layer with a larger critical impact velocity to be cut by the first rotating unit. Therefore, it becomes unnecessary to cut the first layer with the second rotating unit, so that a load on the second rotating unit can be reduced. For example, the impact velocity of the impacting body of the second rotating unit can be set lower than that of the first rotating unit.

It is preferable that the impacting body of the first rotating unit is allowed to impact on the first layer at least at the critical impact velocity of the first layer, and it is particularly preferable that the impacting body of the first rotating unit is allowed to impact at a speed at least twice as high as the critical impact velocity of the first layer. In this manner, the first layer that is difficult to cut can be cut stably based on a processing principle of the present invention described above. Also, a stable high-speed cutting becomes possible along with an increase in the impact velocity of the impacting body. More specifically, although it depends on a material for the first layer, the impacting body of the first rotating unit desirably is allowed to impact on the first layer at a speed of at least about 139 m/second (about 500 km/hour), in particular, at a speed of at least about 340 m/second (about 1224 km/hour). Accordingly, the first layer can be cut at a high speed regardless of the material and kind of the object to be processed.

On the other hand, the impacting body of the second rotating unit can be allowed to impact on the second layer at a speed not greater than the critical impact velocity of the first layer. In other words, by cutting the first layer almost entirely by the first rotating unit, the impact velocity of the impacting body of the second rotating unit can be set lower than that of the first rotating unit. This can reduce the rotational speed of the second rotating unit, thus relaxing the design strength of each part of the rotating unit (for example, a spindle, a peripheral region of a through hole of the impacting body through which the spindle is passed, or the like). This also eliminates the need for a large driving device for a high-speed rotation. Thus, it becomes possible to reduce the cost and improve the reliability and safety. In the case described above, it is preferable that the impacting body of the second rotating unit is allowed to impact at least at the critical impact velocity of the second layer. In this manner, the second layer can be cut stably based on the processing principle of the present invention described above. Nevertheless, there are some cases where, depending on the material of the second layer, the second layer can be cut even when allowing the impacting body of the second rotating unit to impact at the critical impact velocity of the second layer or lower. In such cases, it is preferable in view of the lifetime of the impacting body, cost, reliability, safety and energy consumption that it is allowed to impact at as low a speed as possible.

In the above method, it is preferable that the circular path of the tip of the impacting body of the first rotating unit has a smaller radius than the circular path of the tip of the impacting body of the second rotating unit. By reducing the size of the circular path of the first rotating unit, it becomes easier to rotate the first rotating unit at a high speed. Therefore, the impacting body of the first rotating unit can be allowed to impact on the first layer with a larger critical impact velocity at a higher speed.

### BRIEF DESCRIPTION OF DRAWINGS

FIG. 1 is a top view showing a cutting device according to a first embodiment of the present invention.

FIG. 2 is a sectional view taken along the line II-II in FIG. 1 in an arrow direction.

FIG. 3A is a front view showing a specific configuration of a square impacting body used in the cutting device according to the first embodiment, and FIG. 3B is a side view thereof.

FIG. 4A is a front view showing a specific configuration of a substantially bow-shaped impacting body used in the cutting device according to the first embodiment, and FIG. 4B is a side view thereof.

FIG. 5A is a front view showing a cruciform impacting body, and FIG. 5B is a sectional view thereof taken along the line 5B-5B in FIG. 5A in an arrow direction.

FIG. 6A is a front view showing a modified cruciform impacting body, and FIG. 6B is a side view thereof.

FIG. 7A is a front view showing a disc-shaped impacting body, and FIG. 7B is a sectional view thereof taken along the line 7B-7B in FIG. 7A in an arrow direction.

FIG. 8A is a front view showing a regular-hexagonal impacting body, and FIG. 8B is a sectional view thereof taken along the line 8B-8B in FIG. 8A in an arrow direction.

FIG. 9A is a front view showing a substantially bell-shaped impacting body, and FIG. 9B is a side view thereof.

FIG. 10A is a front view showing a modified pentagonal impacting body, and FIG. 10B is a side view thereof.

FIG. 11A is a front view showing a substantially “9”-shaped impacting body, and FIG. 11B is a sectional view thereof taken along the line 11B-11B in FIG. 1A in an arrow direction.

FIG. 12A is a front view showing a substantially bow-shaped impacting body, and FIG. 12B is a side view thereof.

FIG. 13A is a front view showing a substantially bow-shaped impacting body, and FIG. 13B is a side view thereof.

FIG. 14 is a side view showing cutting and processing equipment in a second embodiment of the present invention.

### BEST MODE FOR CARRYING OUT THE INVENTION

The following is a description of embodiments of a cutting device and a cutting method of the present invention, with reference to the accompanying drawings.

(First Embodiment)

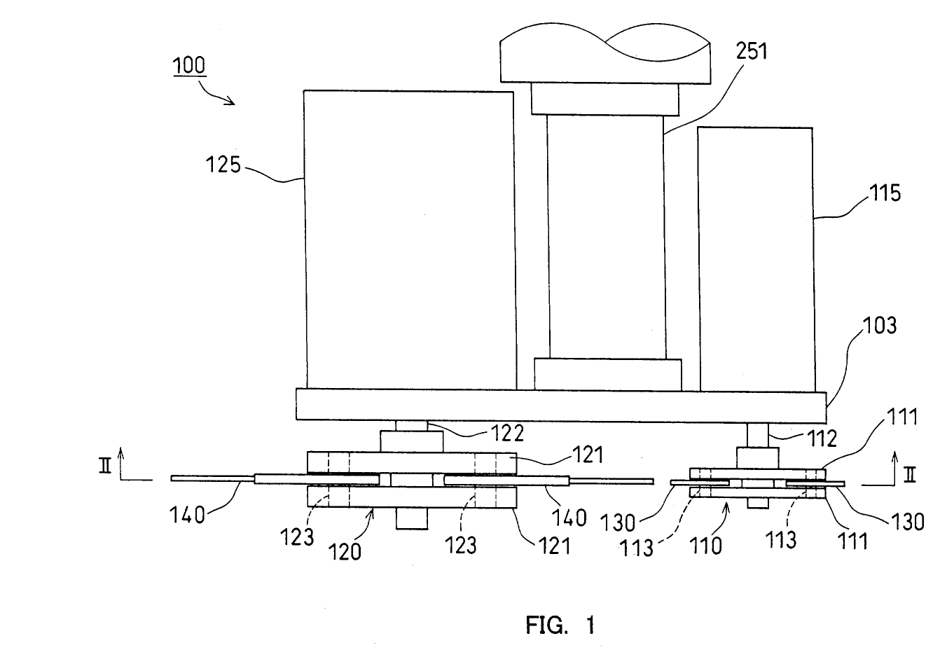

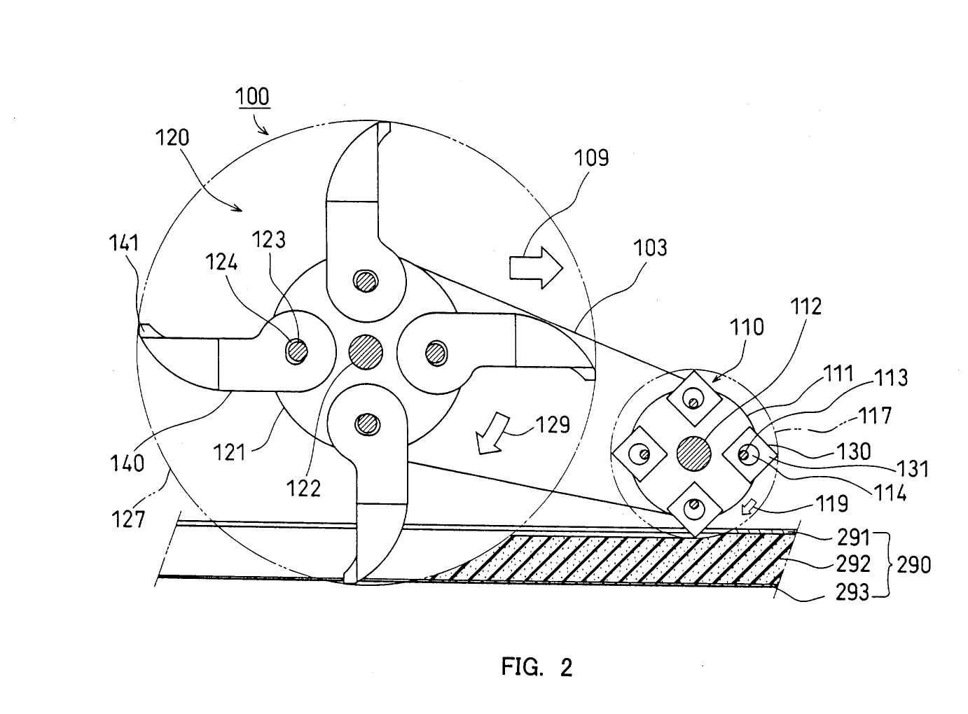

FIG. 1 is a top view showing a cutting device according to a first embodiment of the present invention, and FIG. 2 is a sectional view thereof taken along the line II-II in FIG. 1 in an arrow direction, showing the state of cutting a workpiece as well.

A cutting device 100 in the first embodiment has a first rotating unit 110 and a second rotating unit 120 as shown in FIGS. 1 and 2.

The first rotating unit 110 has a pair of discs (rotors) 111, 111 that are spaced at a predetermined distance and attached to a main shaft 112 with their principal planes opposing each other, and impacting bodies (hard solid bodies) 130 mounted rotatably to spindles 113 provided between the pair of discs 111, 111. The main shaft 112 is connected to a rotating shaft of a driving motor 115, so that the first rotating unit 110 is rotated about the main shaft 112 serving as a rotational center. Four spindles 113 are provided on the circumference of a circle, whose center corresponds to this rotational center, in such a manner as to be spaced at equal angles.

Similarly, the second rotating unit 120 has a pair of discs (rotors) 121, 121 that are spaced at a predetermined distance and attached to a main shaft 122 with their principal planes opposing each other, and impacting bodies (hard solid bodies) 140 mounted rotatably to spindles 123 provided between the pair of discs 121, 121. The main shaft 122 is connected to a rotating shaft of a driving motor 125, so that the second rotating unit 120 is rotated about the main shaft 122 serving as a rotational center. Four spindles 123 are provided on the circumference of a circle, whose center corresponds to this rotational center, in such a manner as to be spaced at equal angles.

The first rotating unit 110 and the second rotating unit 120 are held by a common base 103 so that the directions of the axes of rotation thereof are parallel and the principal planes of the discs 111 and the discs 121 are on substantially the same plane, in other words, so that a circular path 117 of cutting blades 131 at the tip of the impacting bodies 130 and a circular path 127 of cutting blades 141 at the tip of the impacting bodies 140 during the rotation substantially are on the same plane. The base 103 is mounted on a robot arm 251.

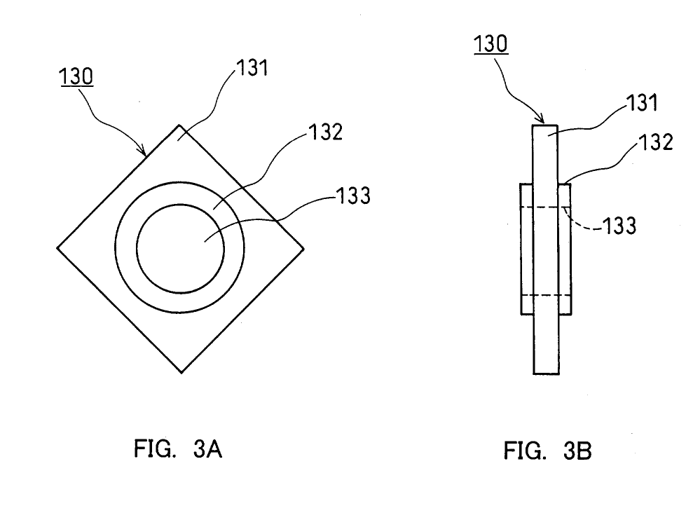

FIGS. 3A and 3B show a specific configuration of the impacting body 130. FIG. 3A is a front view, and FIG. 3B is a side view. As shown in these figures, the square impacting body 130 has a shape such as the one obtained by attaching a cylindrical body 132 with a through hole 133 to the central portion of a plate member with a planar shape of a square and a predetermined thickness. The cylindrical body 132 is made to have a length larger than the thickness of the square plate member, thus securing mechanical strength. Four corners 131 of the square plate member correspond to cutting blades in a conventional tool and impact on the workpiece. The impacting body 130 is attached to the rotating unit 110 by passing the spindle 113 through the through hole 133. As shown in FIGS. 1 and 2, the impacting body 130 is attached so that a part of its periphery (in particular, the cutting blade 131) is located beyond the periphery of the disc 111 when the rotating unit 110 rotates. In the device shown in FIGS. 1 and 2, four impacting bodies 130 are arranged on the principal planes of the discs 111 so as to be spaced equally from each other.

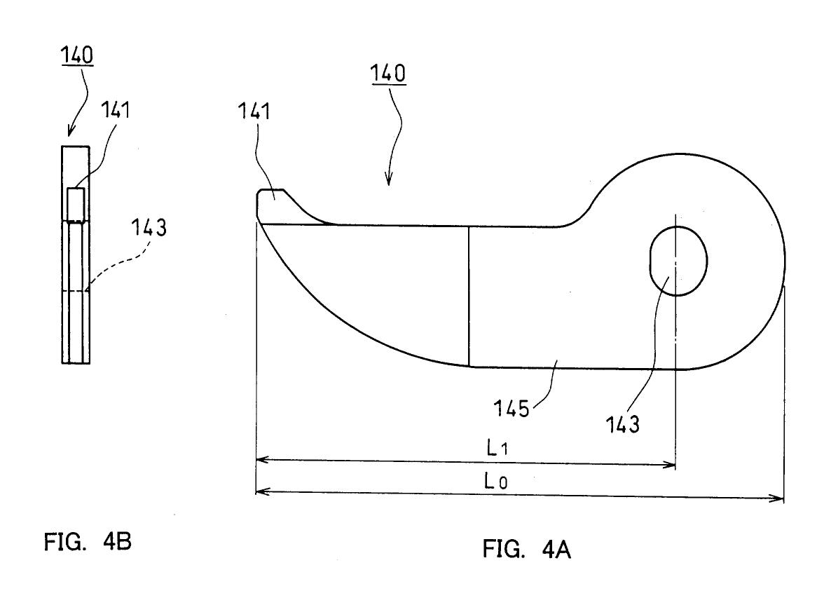

FIGS. 4A and 4B show a specific configuration of the impacting body 140. FIG. 4A is a front view, and FIG. 4B is a side view. As shown in these figures, the substantially bow-shaped impacting body 140 has a floating portion 145, a through hole 143 provided at one end of the floating portion 145 and the cutting blade 141 provided at the other end of the floating portion 145. The floating portion 145 has a shape approximately that of a substantially-bow shape that is formed of a substantially circular-arc portion and a chord extending between both ends of the circular-arc, or a substantially-bow shape that is substantially the same as that of pieces obtained by bisecting an ellipse or an oval along its longitudinal direction. The cutting blade 141 is formed to be thick so as to be resistant to shock at the time of impacting on the workpiece, the peripheral portion of the through hole 143 is formed to be thick so as to be resistant to centrifugal force during rotation, and other portions are formed to be thin so as to reduce weight. The impacting body 140 is attached to the rotating unit 120 with its cutting blade 141 facing forward in the rotational direction by passing the spindle 123 through the through hole 143. As shown in FIGS. 1 and 2, the impacting body 140 is attached so that a part of its periphery (in particular, the cutting blade 141) is located beyond the periphery of the disc 121 when the rotating unit 120 rotates. In the device shown in FIGS. 1 and 2, four impacting bodies 140 are arranged on the principal planes of the discs 121 so as to be spaced equally from each other. The planar shape of the through hole 143 preferably is an ellipse as shown in FIGS. 4A and 4B. More accurately, the planar shape of the through hole 143 is a circular-arc elliptical shape that is formed by two circular arcs with different radii whose centers are the center of gravity of the impacting body 140 and semicircles connecting both ends of these two circular arcs in the circumferential direction. By forming the through hole 143 to be a circular-arc elliptical hole whose center is the center of gravity of the impacting body 140, the displacement of the impacting body 140 when the impacting body 140 rebounds in such a manner as to rotate about its center of gravity after impacting on a workpiece can be absorbed well, thus improving the cutting performance. Since a rotationally symmetric impacting body such as the impacting body 130 shown in FIGS. 3A and 3B has a center of gravity substantially corresponding to the center of the through hole 133, the planar shape of the through hole 133 is formed to be circular, thereby absorbing the above-mentioned displacement caused by the rebound at the time of impacting.

A predetermined fitting gap 114 is provided between the spindle 113 and the through hole 133 of the impacting body 130. Similarly, a predetermined fitting gap 124 is provided between the spindle 123 and the through hole 143 of the impacting body 140. By providing the fitting gaps 114, 124, the impacts on the cutting blades 131, 141 and the spindles 113, 123 are relieved when the impacting bodies impact on the workpiece even though the rotors 111, 121 rotate at a high speed, thus preventing components of the rotating units 110, 120 such as the spindles from being damaged.

The following is a description of an example of cutting a workpiece (an object to be processed) by using the above-described cutting device 100. The description is directed to the case of cutting a workpiece 290 having a layered structure including a steel plate layer 291, a urethane foam layer 292 and a resin plate layer 293 in this order as shown in FIG. 2. The cutting device 100 and the workpiece 290 are arranged such that the directions of the axes of rotation of the main shafts 112, 122 are substantially parallel with a surface of the plate-like workpiece 290. Then, the cutting device 100 is moved in the direction indicated by an arrow 109 while rotating the first rotating unit 110 and the second rotating unit 120 at a high speed in the directions indicated respectively by arrows 119, 129. The moving direction 109 is parallel with the principal planes of the discs 111, 121 and also with the surface of the workpiece 290. Accordingly, the impacting bodies 130 of the first rotating unit 110 first impact on the steel plate layer 291 on the surface of the workpiece 290, and the steel plate layer 291 and a part of the upper portion of the urethane layer 292 are cut, so that a groove having a predetermined width and depth is formed on the upper surface of the workpiece 290. Subsequently, the impacting bodies 140 of the second rotating unit 120 advance along this groove, thus cutting the lower portion of the urethane layer 292 and the resin plate layer 293, which have not been subjected to the impacting bodies 130.

At this time, the rotating units are rotated so that at least either of the impacting bodies 130 or the impacting bodies 140 impact on the workpiece at least at the critical impact velocity of the workpiece 290. In the above example, it is preferable that the impacting bodies 130 impacting on the steel plate layer 291, which is made of a high hardness material and difficult to cut, impact at least at the critical impact velocity of a material of the steel plate layer 291. With respect to the rotational speed, a variation of about ±10% is allowable due to the variation in power supply voltage or other reasons.

The impact velocity of the impacting bodies 130 against the workpiece 290 naturally corresponds to the rotational speed of the pair of discs (rotors) 111. The present embodiment employs a rotational speed in a high rotational speed range of, for example, 10,000 to 60,000 rpm as the rotational speed of the pair of discs 111. The high rotational speed range enables the impact force of the impacting bodies 130 to increase and the lifetime thereof to be extended by an air-cooling effect and work hardening. In the cutting device 100 shown in FIG. 1, four impacting bodies 130 are spaced equally between the principal planes of the discs 111. Therefore, the impacting frequency of the first rotating unit 110 against the workpiece 290 is at least (10,000 rotations/minute)×four impacting bodies=40,000 times/minute.

In the above example, the impacting bodies 140 of the second rotating unit 120 need not be allowed to impact at least at the critical impact velocity of the workpiece 290 (in particular, the urethane layer 292 and the resin plate layer 293). Since the urethane layer 292 and the resin plate layer 293 have a low hardness and do not cause a brittle fracture easily, even when the impacting bodies 140 are allowed to impact at the critical impact velocity of the workpiece or lower, only the vicinity of the part subjected to the impact is smashed and can be cut easily. In such cases, it may be possible to choose to rotate the second rotating unit 120 not at a high speed but at a low speed, thereby saving a driving energy. This also eliminates the need for the design that is resistant to a great centrifugal force generated at the time of high-speed rotation, making it possible to reduce the size and weight of the second rotating unit 120 and improve safety. Also, it becomes possible to reduce the size of the driving motor 125. In this way, the equipment cost and operating cost can be reduced. Of course, there are some cases where, depending on a material of the layer to be cut mainly by the impacting bodies 140 of the second rotating unit 120, the impacting bodies 140 preferably are allowed to impact at least at the critical impact velocity of this material.

As described above, in the cutting device 100 of the present embodiment, the impacting bodies 130 of the first rotating unit 110 cut only the top layer of the workpiece 290, and the impacting bodies 140 of the following second rotating unit 120 cut deeply to the back surface thereof. In the present embodiment, in order that the impacting bodies of these rotating units have different cutting depths, the circular paths 117, 127 of the tips of the cutting blades of the impacting bodies of these rotating units are made to have different radii and the main shafts 112, 122 are made to have different heights above (distances from) the surface of the workpiece 290 as shown in FIG. 2. Simply changing the heights of the axes of rotation (the main shafts) of these rotating units while keeping their configurations completely the same also can change the cutting depths of the impacting bodies of these rotating units. However, there are some cases where the circular path 117 of the first rotating unit 110 preferably is designed to have a smaller radius than the circular path 127 of the second rotating unit 120 by modifying the shapes of the impacting bodies as described in the present embodiment. The reason follows. In order to allow the impacting bodies to impact on the workpiece at least at the critical impact velocity, the rotating unit has to be rotated at a high speed. On the other hand, in order to cut the workpiece having a certain thickness, the projecting length of the impacting bodies beyond the disc during rotation has to be longer than the thickness of the workpiece. Thus, there is a lower limit for the size of the impacting body. When a large impacting body is attached to the rotating unit, the weight of the impacting body and the distance from the rotational center to the center of gravity of the impacting body increase. Therefore, as the impacting body becomes larger, the centrifugal force generated at the time of high-speed rotation increases in an accelerating manner. As a result, it becomes necessary to design the device having a mechanical strength that can withstand this centrifugal force, leading to a further increase in weight and costs. Accordingly, when cutting the workpiece 290 having a layered structure and whose surface and back layers have different critical impact velocities as in the above example, the workpiece is disposed so that the steel plate layer 291 having a large critical impact velocity can be cut first and the circular path 117 of the first rotating unit 110 cutting the steel plate layer 291 is made to be smaller than the circular path 127 of the second rotating unit 120. Consequently, the size of the impacting bodies 130 of the first rotating unit 0.110 can be reduced, and thus their radius of gyration also decreases, thus achieving a high-speed rotation of the first rotating unit 110 easily. On the other hand, since the rotational speed of the second rotating unit 120 cutting the urethane layer 292 and the resin plate layer 293 having a relatively small critical impact velocity can be made lower than that of the first rotating unit 110, the strength design can be carried out relatively easily even when providing large impacting bodies 140.

The cutting device of the present invention includes at least two rotating units. There are the following problems in the case of cutting the workpiece at one time with only a single rotating unit. For example, when the workpiece is thick, the projecting length of the impacting bodies beyond the disc at the time of rotation has to be greater than the workpiece thickness in order to cut the workpiece at one time with one rotating unit. This increases the size and weight of the impacting bodies. In order to rotate them at a high speed, the mechanical strength needs to be improved, leading to an increase in the weight of the rotating unit and higher costs as described above. Also, when cutting the workpiece formed by layering different kinds of materials, the impacting bodies have to be allowed to impact at least at the largest critical impact velocity among those of the layered materials in order to cut the workpiece at one time with one rotating unit. Thus, it is necessary to rotate the rotating unit at a high speed. Therefore, the strength design and driving mechanism of the rotating unit have to be brought into correspondence with such a rotation, which brings about much waste. Furthermore, when attempting to cut the workpiece 290 at one time with only the second rotating unit 120 provided with, for example, the substantially bow-shaped impacting bodies 140 with longer projecting lengths, the impact on the difficult-to-machine steel plate layer 291 causes each impacting body 140 to rebound and rotate about the spindle 123 and then interfere with the impacting body 140 positioned toward the back in the rotational direction, which is supposed to impact on the workpiece subsequently. Also, when the workpiece is thick, the speed of the impacting body lowers at some midpoint in the thickness direction of the workpiece, and then this impacting body interferes with the subsequent impacting body 140 within the workpiece. Such interferences between the impacting bodies deteriorate the cutting efficiency and the reliability of the cutting device. When the intervals between the impacting bodies are increased for the purpose of preventing the interference therebetween, the number of the impacting bodies declines, leading to fewer impacting times and lower cutting efficiency. For the above reasons, the workpiece is cut by sequentially increasing the cutting depth using a plurality of the cutting units, thereby achieving an excellent cutting performance with respect to a thick workpiece and a workpiece formed by layering different kinds of materials. As becomes clear from the above, when the workpiece is relatively thin, it also is possible to cut the workpiece at one time with only a single rotating unit.

Impacting bodies attachable to the rotating units are not limited to those shown in FIGS. 3A and 3B and FIGS. 4A and 4B, but can be those with various shapes. In the following, examples of usable shapes of impacting bodies will be described.

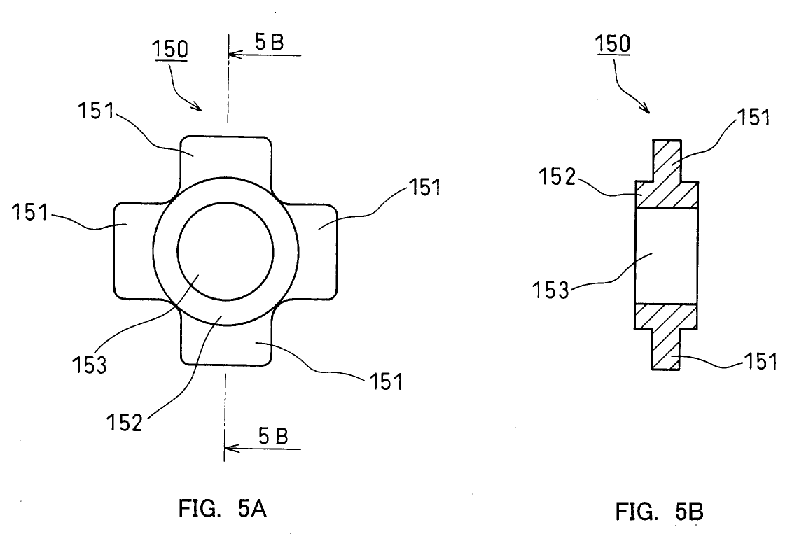

FIGS. 5A and 5B show a cruciform impacting body as an example of an impacting body having projections at substantially equal angles on its periphery, with FIG. 5A being a front view and FIG. 5B being a sectional view of FIG. 5A taken along the line 5B-5B in an arrow direction. The cruciform impacting body 150 has four rectangular projections 151, which are spaced at equal angles in a circumferential direction, on the peripheral surface of a cylindrical body 152 having a through hole 153. The rectangular projections 151 correspond to cutting blades in a conventional tool and impact on the workpiece. The number of the rectangular projections (cutting blades) 151 is not limited to four as in the present example but may be less (two, three) or more (for example, five, six).

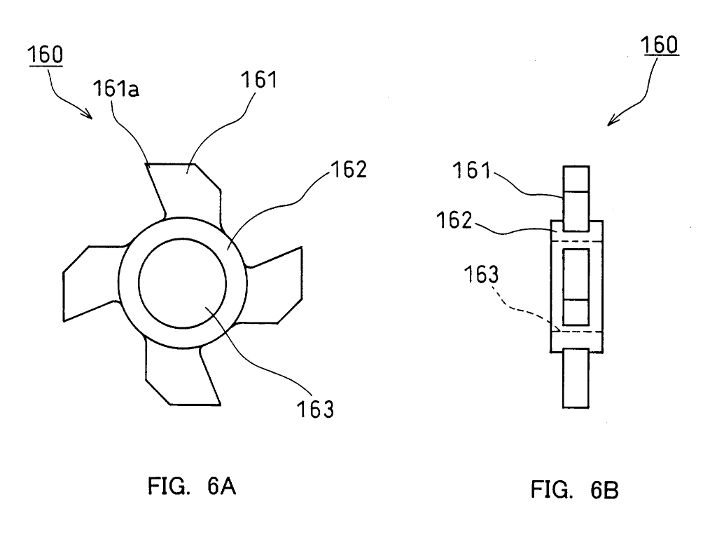

FIGS. 6A and 6B show a modified cruciform impacting body as another example of an impacting body having projections at substantially equal angles on its periphery, with FIG. 6A being a front view and FIG. 6B being a side view. A modified cruciform impacting body 160 is formed by modifying the shape of the rectangular projections 151 in the cruciform impacting body 150 shown in FIGS. 5A and 5B. In other words, the modified cruciform impacting body 160 has four substantially parallelogram projections 161, which are spaced at equal angles in a circumferential direction, on the peripheral surface of a cylindrical body 162 having a through hole 163. The projections 161 are attached so that an acute end 161a on a periphery of each projection 161 faces the direction of impacting on the workpiece. The number of the substantially parallelogram projections 161 is not limited to four as in the present example but may be less (two, three) or more (for example, five, six). Also, instead of the substantially parallelogram projections 161, projections such as substantially triangle projections, arch-shaped projections or substantially semicircular projections also may be provided in such a manner as to be spaced at equal angles.

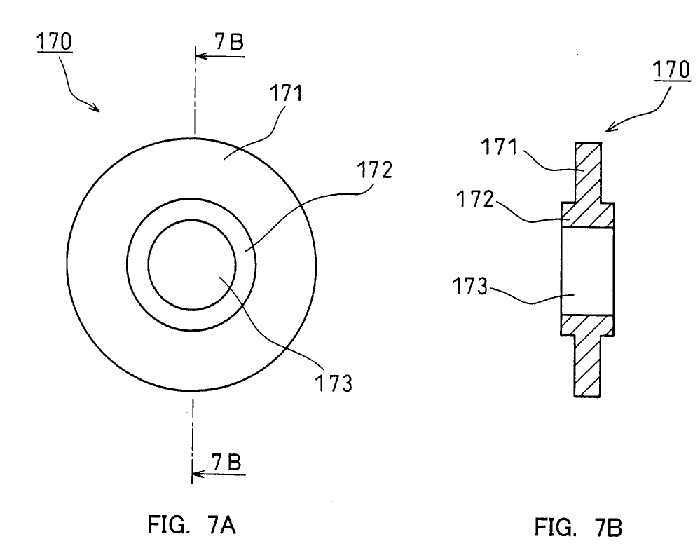

FIGS. 7A and 7B show a disc-shaped impacting body 170, with FIG. 7A being a front view and FIG. 7B being a sectional view taken along the line 7B-7B in FIG. 7A in an arrow direction. The disc-shaped impacting body 170 has a shape such as the one obtained by inserting a cylindrical body 172 with a through hole 173 into the central portion of a ring cutting blade 171 with a predetermined thickness.

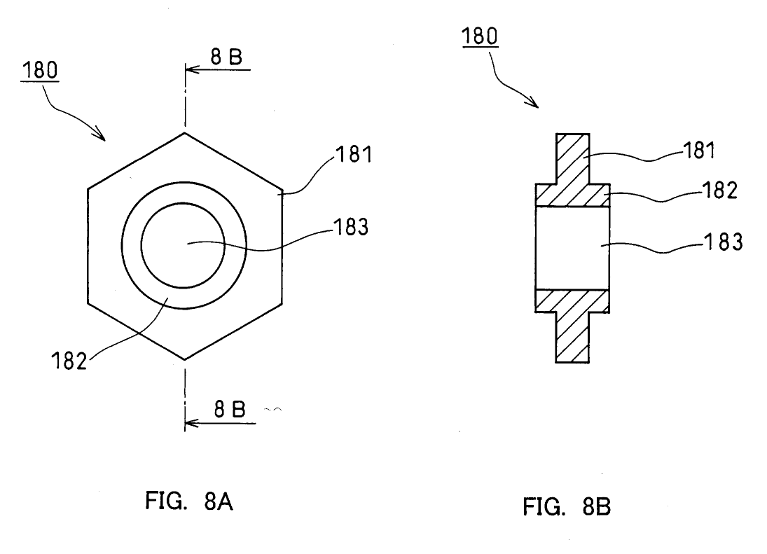

FIGS. 8A and 8B show a regular-hexagonal impacting body, with FIG. 8A being a front view and FIG. 8B being a sectional view taken along the line 8B-8B in FIG. 8A in an arrow direction. The regular-hexagonal impacting body 180 has a shape such as the one obtained by inserting a cylindrical body 182 with a through hole 183 into the central portion of a plate member with an outer shape of regular hexagon and a predetermined thickness. Six corners 181 on the periphery of the plate member serve as cutting blades. Instead of the regular hexagon, the plate member can have an outer shape of other regular polygons such as a regular triangle, a regular pentagon and a regular octagon.

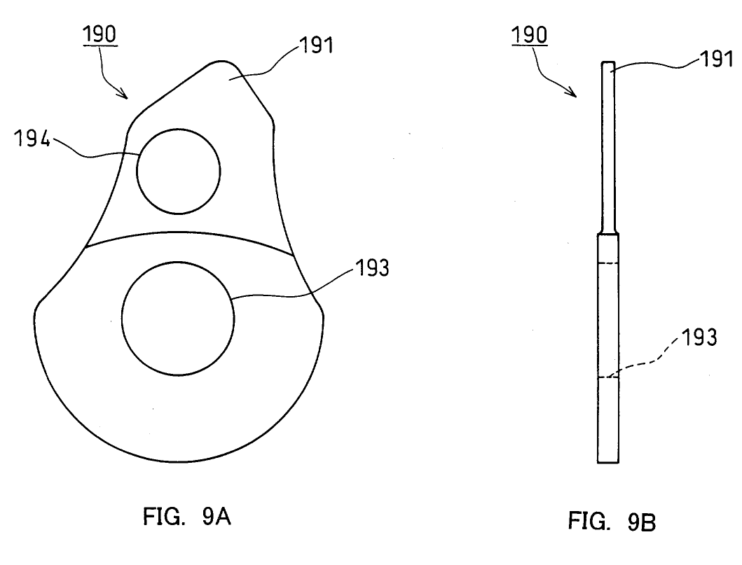

FIGS. 9A and 9B show a substantially bell-shaped impacting body, with FIG. 9A being a front view and FIG. 9B being a side view. A substantially bell-shaped impacting body 190 has a planar shape of a bell shape or a suitable variation thereof. An end corresponding to the portion by which a bell is suspended is a cutting blade 191 for impacting on the workpiece, and a wide region on the opposite side is provided with a through hole 193 through which a spindle is passed. Furthermore, a through hole 194 is provided for reducing weight, and the region in which the through hole 194 is formed is thinner than the region in which the through hole 193 is formed.

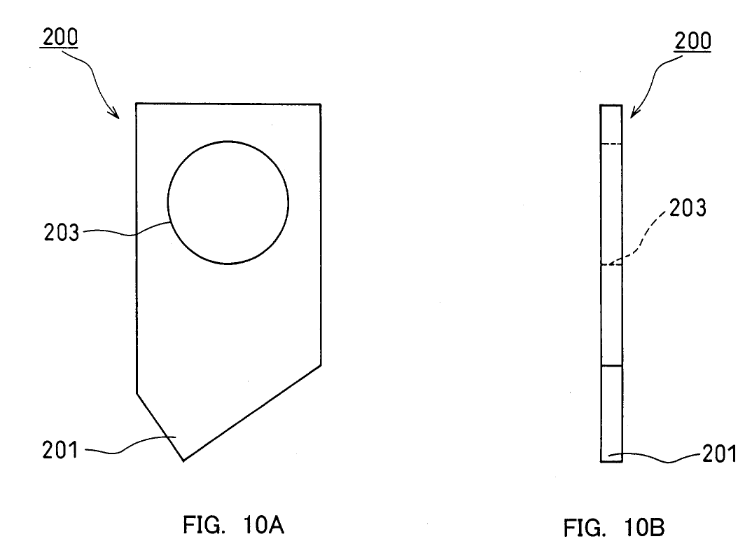

FIGS. 10A and 10B show a modified pentagonal impacting body, with FIG. 10A being a front view and FIG. 10B being a side view. A modified pentagonal impacting body 200 has a planar shape that is substantially the same as a pentagon obtained by cutting off corners on both sides on one shorter side of a rectangle. A resultant corner at the tip formed by cutting off the corners on the both sides is a cutting blade 201 for impacting on the workpiece. On the opposite side, a through hole 203 through which a spindle is passed is formed.

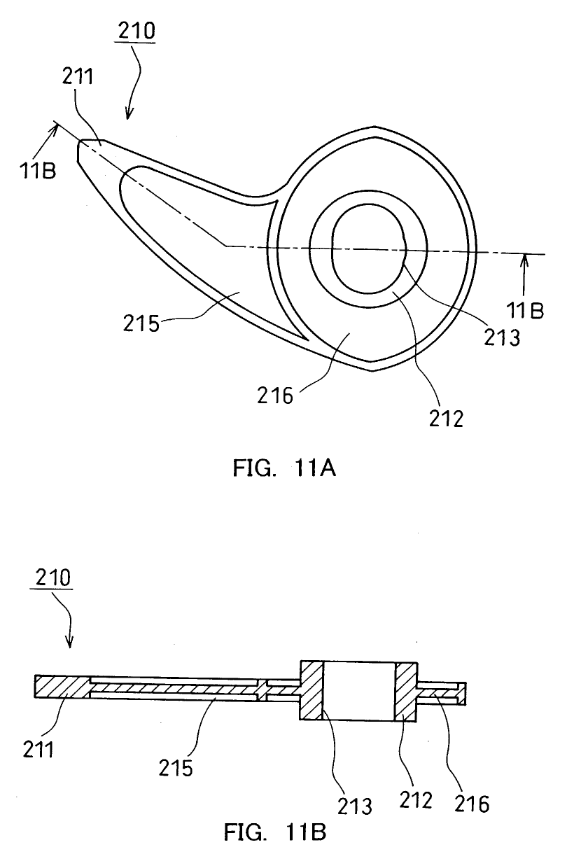

FIGS. 11A and 11B show a substantially “9”-shaped impacting body, with FIG. 11A being a front view and FIG. 11B being a sectional view taken along the line 11B-11B in FIG. 1A in an arrow direction. A substantially “9”-shaped impacting body 210 has a substantially disc-shaped plate 216 having a substantially circular (or substantially oval) shape and a wedge-shaped portion 215, which are connected so as to form a substantially “9” shape or a substantially “,” (comma) shape. An end of the wedge-shaped portion 215 is a cutting blade 211 for impacting on the workpiece. In addition, the substantially central portion of the substantially disc-shaped plate 216 is provided with a through hole 213 through which a spindle is passed, and the periphery thereof is formed to be thick for raising the mechanical strength. Furthermore, the edge portions of the substantially disc-shaped plate 216 and the wedge-shaped portion 215 are formed to be thick and inner regions thereof are formed to be thin for reducing weight while maintaining the necessary mechanical strength.

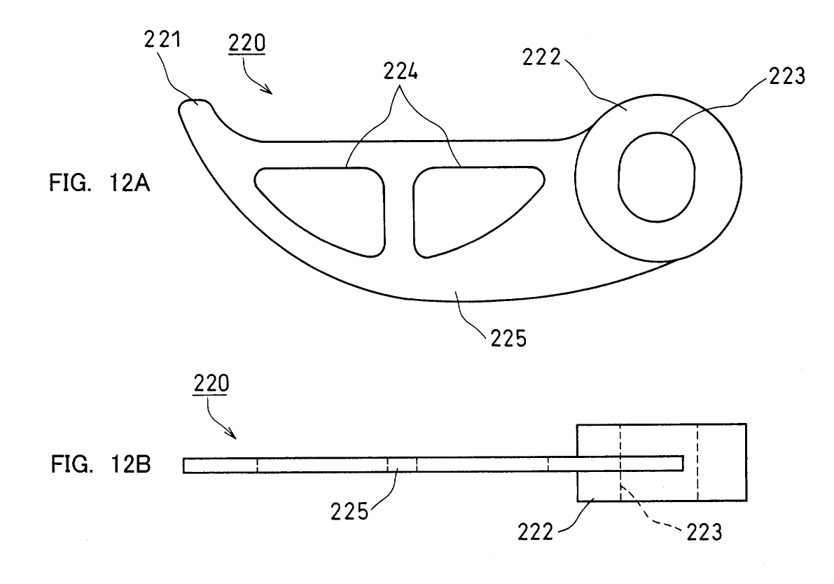

FIGS. 12A and 12B show a substantially bow-shaped impacting body, with FIG. 12A being a front view and FIG. 12B being a side view. A substantially bow-shaped impacting body 220 shown in FIGS. 12A and 12B is an example of modifying the substantially bow-shaped impacting body 140 shown in FIGS. 4A and 4B. As the substantially bow-shaped impacting body 140 shown in FIGS. 4A and 4B, the substantially bow-shaped impacting body 220 has a substantially bow-shaped floating portion 225, a through hole 223 having a circular-arc elliptical shape provided at one end of the floating portion 225 and a cutting blade 221 provided at the other end of the floating portion 225. The substantially bow-shaped impacting body 220 is different from the substantially bow-shaped impacting body 140 shown in FIGS. 4A and 4B in the following points. First, the peripheral region of the through hole 223 through which a spindle is passed is formed to be still thicker, thus improving a mechanical strength to resist a centrifugal force generated at the time of rotation. Second, the floating portion 225 is provided with through holes 224 so as to reduce weight, thus reducing the centrifugal force generated at the time of rotation.

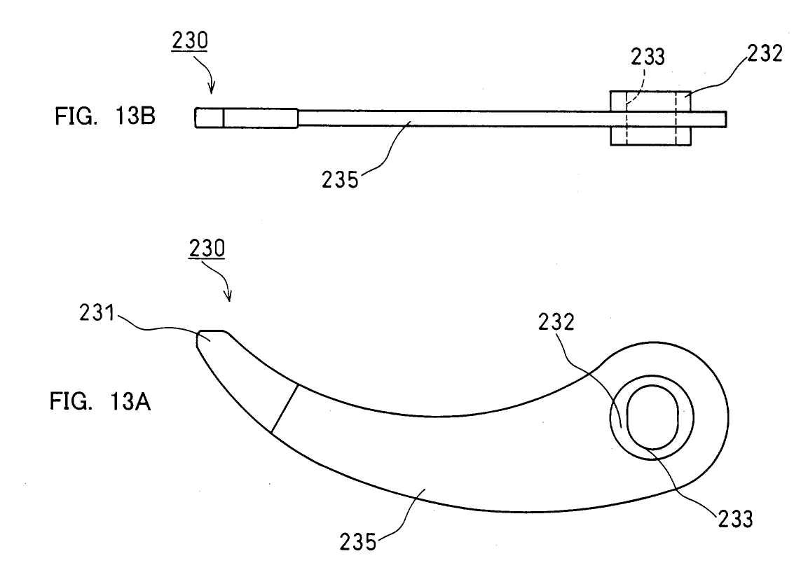

FIGS. 13A and 13B show another example of a substantially bow-shaped impacting body, with FIG. 13A being a front view and FIG. 13B being a side view. A substantially bow-shaped impacting body 230 shown in FIGS. 13A and 13B is an example of modifying the substantially bow-shaped impacting body 140 shown in FIGS. 4A and 4B. The substantially bow-shaped impacting body 230 has a floating portion 235 like the substantially bow-shaped impacting body 140 shown in FIGS. 4A and 4B, but a portion corresponding to the chord of the bow is bent in the same direction as the substantially circular arc portion in the impacting body 230, whereas it is a straight line in the impacting body 140 shown in FIGS. 4A and 4B. As in the substantially bow-shaped impacting body 140 shown in FIGS. 4A and 4B, a through hole 233 having a circular-arc elliptical shape is formed at one end of the floating portion 235 and a cutting blade 231 is formed at the other end of the floating portion 235. In addition, as in the substantially bow-shaped impacting body 220 shown in FIGS. 12A and 12B, the peripheral region of the through hole 233 through which a spindle is passed is formed to be thick, thus improving a mechanical strength to resist a centrifugal force generated at the time of rotation.

The impacting body can have various shapes other than the above as long as it has a through hole through which a spindle can be passed and a cutting blade to impact on the workpiece. Furthermore, the tips of the through hole and the cutting blade may be made thick for raising the mechanical strength, while a through hole may be provided suitably or the plate thickness may be reduced partially so as to reduce weight for the purpose of reducing the centrifugal force that is generated.

Among the impacting bodies described above, impacting bodies that are rotationally symmetric with respect to an axis of the through hole through which a spindle is inserted such as the impacting body 130 (FIGS. 3A and 3B), the impacting body 150 (FIGS. 5A and 5B), the impacting body 160 (FIGS. 6A and 6B), the impacting body 170 (FIGS. 7A and 7B) and the impacting body 180 (FIGS. 8A and 8B) have a smaller projecting length beyond the rotor but can achieve lighter weight. Therefore, they can be used suitably as an impacting body of a rotating unit rotating at a very high speed or a rotating unit that does not require a great cutting depth (the first rotating unit 110 in the above example). On the other hand, impacting bodies provided with a through hole through which a spindle is inserted at one end of an oblong floating portion such as the impacting body 140 (FIGS. 4A and 4B), the impacting body 220 (FIGS. 12A and 12B) and the impacting body 230 (FIGS. 13A and 13B) can achieve a larger projecting length beyond the rotor so as to obtain a greater cutting depth, but are a relatively heavy and have the center of gravity far from an axis of rotation of the rotating unit. Accordingly, the strength to withstand the centrifugal force generated when rotating the unit at a very high speed has to be considered. Therefore, they can be used suitably as an impacting body of a rotating unit rotating at a relatively low speed or a rotating unit that requires a great cutting depth (the second rotating unit 120 in the above example). Furthermore, the shapes of the impacting body 190 (FIGS. 9A and 9B), the impacting body 200 (FIGS. 10A and 10B) and the impacting body 210 (FIGS. 11A and 11B) have intermediate characteristics between the above two groups and can be used for both the first rotating unit 110 and the second rotating unit 120 in the above example.

Besides the disc type, the rotors 111, 121 may have an arbitrary shape such as a regular polygon. However, as a matter of course, the rotors should be balanced during rotation.

Next, examples of dimensions and materials of the rotors and the impacting bodies are described. In the cutting device according to the embodiment shown in FIGS. 1 and 2, the disc 111 had a diameter of 100 mm and a plate thickness of 5 mm and was made of carbon steel for machine structural use, and the disc 121 had a diameter of 200 mm and a plate thickness of 10 mm and was made of carbon steel for machine structural use. The spindle 113 had a diameter of 10 mm and was made of carbon steel for machine structural use or carbon tool steel (JIS code: SK2), and the spindle 123 had a diameter of 21 mm and was made of carbon steel for machine structural use or carbon tool steel (JIS code: SK2). The impacting body 130 had a 34.2 mm×34.2 mm square plate member with a thickness of 5 mm, the cylindrical body 132 with an outer diameter of 25 mm and a length of 10 mm and the through hole 133 with an inner diameter of 17 mm. The impacting body 140 had a total length L0 of 200 mm, a length L1 from substantially the center of the through hole 143 to the end of the cutting blade 141 of 160 mm, the through hole 143 thereof had an inner dimension along its lengthwise direction of 26 mm and that along its widthwise direction of 22 mm, and the cutting blade 141, the peripheral portion of the through hole 143 and the other portions had thicknesses of 6 mm, 10 mm and 5 mm, respectively, as shown in FIGS. 4A and 4B. The impacting bodies 130 and 140 were made of any one material selected from carbon steel for machine structural use (S45C), carbon tool steel (SK2), high speed tool steel (SKH2), Ni—Cr steel (SNC631), Ni—Cr—Mo steel (SNCM420), Cr—Mo steel (SCM430), chromium steel (SCr430) and manganese steel for machine structural use (SMn433).

In the example of cutting a workpiece, which is shown in FIGS. 1 and 2, the disc 110 was rotated at 30,000 rpm in the direction indicated by the arrow 119, and the impact velocity of the impacting bodies 130 against the steel plate layer 291 (a 1-mm-thick cold-rolled steel sheet) as the top layer of the workpiece 290 was set to be about 157 m/second (565 km/hour). Also, the disc 120 was rotated at 3000 rpm in the direction indicated by the arrow 129, and the impact velocity of the impacting bodies 140 against the urethane layer 292 (a 60-mm-thick urethane foam) and the resin plate layer 293 (a 1-mm-thick ABS resin (acrylonitrile-butadiene-styrene copolymer)) of the workpiece 290 was set to be about 72 m/second (260 km/hour). The workpiece 290 was fixed, and the robot arm 251 was controlled to move the cutting device 100 at a moving speed for cutting of 50 mm/second in the direction indicated by the arrow 109. In this case, the impacting frequencies were (30,000 rotations/minute)×four impacting bodies=120,000 times/minute for the impacting bodies 130 and (3,000 rotations/minute)×four impacting bodies=12,000 times/minute for the impacting bodies 140.

Since the main shaft 112 rotates at a high speed as described above, a great centrifugal force acts on the impacting bodies 130. The centrifugal force causes a high-speed compressive force accompanied with impacts in a limited portion of the steel plate layer 291 including the surface subjected to the impact by the cutting blades 131 of the impacting bodies 130 and the vicinity of the impact surface. Thus, the top layer of the impact surface of the steel plate layer 291 is smashed at a high speed instantaneously. Cut scraps are in a minute granular state. It has been confirmed by a test that the workpiece can be cut even when no sharp cutting blade is provided.

The impact velocity of the impacting bodies 140 against the urethane layer 292 and the resin plate layer 293 is not greater than the critical impact velocity of materials for these layers. Even when the impacting bodies 140 are allowed to impact on these layers at their critical impact velocity or lower, unlike the case of the difficult-to-machine steel plate layer, only the vicinity of the part subjected to the impact is smashed and the fracture does not propagate widely. Thus, the workpiece 290 can be cut substantially along the groove formed by the impacting bodies 130.

In the above, the impact velocities of the impacting bodies 130, 140 are not limited to the above-mentioned specific example and can be set freely depending on the kind of a workpiece, cutting conditions, or the like as long as at least either of them is at least the critical impact velocity of the workpiece (when the workpiece is formed of a layered body including a plurality of layers, the impact velocity of the impacting bodies cutting the layer that is most difficult to cut in view of physical properties such as hardness, brittleness and strength is considered to be at least at the critical impact velocity of the material for this layer). Similarly, the number of impacts by the impacting bodies 130, 140 per unit time also can be changed depending on the kind of a workpiece, cutting conditions, or the like.

When the material of a workpiece is unknown, when a workpiece is formed of a plurality of different kinds of members, or when a member whose material is unknown hides in a part that cannot be seen from the outside, such a workpiece can be cut excellently by setting the impact velocity of the impacting bodies to be somewhat higher.

With respect to the material for the impacting bodies, members other than metallic members also can be used freely as long as they are hard solid bodies.

Furthermore, the number of the impacting bodies provided in one rotating unit may be only one or at least two. In the case of providing a plurality of the impacting bodies, it is preferable to provide them at equal angles with respect to the rotational center of the rotors, because this results in equal impact intervals to allow stable cutting. In the case of using only one impacting body, a balancer (a weight) is provided to secure the rotational balance.

It is preferable that the cutting blade of the impacting body provided in the following rotating unit is designed to have substantially the same thickness as or to be thinner than that provided in the foregoing rotating unit, which cuts into the workpiece earlier. By cutting into the workpiece with the impacting bodies having the same thickness or with decreasing thickness, the following impacting bodies reliably can fit into a groove-like incised portion formed on the workpiece by the foregoing impacting bodies.

Moreover, instead of spacing the pair of rotors so as to arrange the impacting bodies therebetween, only one rotor may be used with the spindles provided on one side thereof perpendicularly thereto with a cantilevered support structure, so that the impacting bodies may be provided on these spindles.

The rotor may be driven to rotate at a high speed using a general spindle motor or the like.

The number of the rotating units is not limited to two as described above but may be three or more. If three or more rotating units are used and the workpiece is cut sequentially by increasing the cutting depth of the impacting bodies of these units as described above, such a workpiece can be cut excellently even when the workpiece is thick or has a multilayered structure. In such cases, it is preferable that the impacting bodies of these rotating units are allowed to impact on the workpiece at least at the critical impact velocity of each material of the workpiece to be cut by the respective units. However, as is already mentioned, there are some cases where, depending on a material of the workpiece, the workpiece can be cut without any problems even when not all the impacting bodies of a plurality of the rotating units are allowed to impact at least at the critical impact velocity.

For example, when the steel plate layer 291 as the top layer of the workpiece 290 is thick and thus the entire thickness thereof is difficult to cut at one time with the first rotating unit in the above example, a third rotating unit that has substantially the same configuration with the first rotating unit is provided between the first rotating unit and the second rotating unit in the cutting device shown in FIGS. 1 and 2. Then, the cutting depth is increased in the order of the first, third and second rotating units, thus cutting the steel plate layer 291 with the first rotating unit and the third rotating unit. In this case, it is needless to say that the impacting bodies of the first and third rotating units preferably are allowed to impact on the steel plate layer 291 at least at the critical impact velocity of the steel plate layer 291.

The plurality of the rotating units constituting the cutting device do not have to be attached to the common base as in the above example, but may be supported and moved individually so as to move along cutting positions on the workpiece sequentially. However, when they are mounted on the common base, it is possible to control the movement of the cutting device as one piece, allowing a simplification of equipment and cost reduction.

In addition, although the workpiece was cut by moving the cutting device while fixing the workpiece in the above example, it also may be cut by moving the workpiece while fixing the cutting device at a predetermined position.

As described above, the impacting bodies of the present invention are not provided with sharp cutting blades as in a conventional cutting tool. The cutting principle of the present invention goes beyond a conventional practical sense and enables even brittle members such as metal, resin, glass, ceramics, or the like to be cut by a single cutting device without using sharp cutting blades by providing the impacting bodies with a far higher speed than that in a conventional cutting tool.

(Second Embodiment)

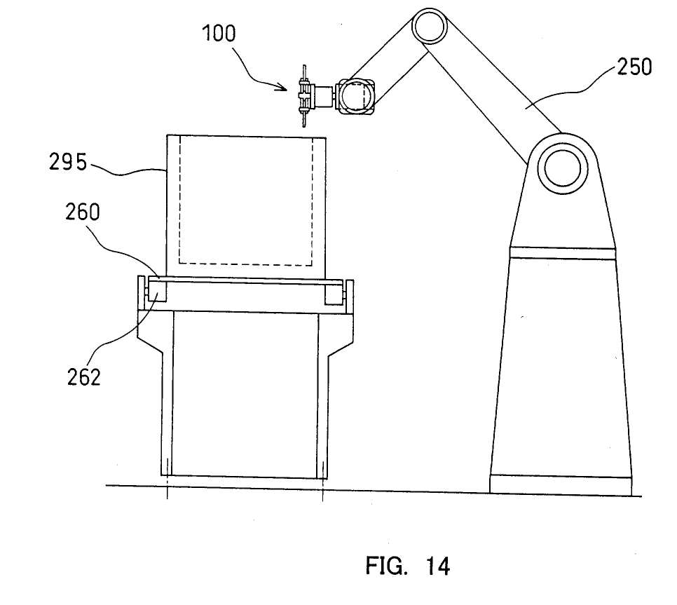

FIG. 14 shows a side view of cutting and processing equipment according to a second embodiment of the present invention. The cutting and processing equipment of the present embodiment has the configuration in which the cutting device 100 of the first embodiment is mounted to a robot arm.

In FIG. 14, numeral 100 indicates the cutting device described in the first embodiment, numeral 250 indicates a commercially available robot controlled with five axes, numeral 295 indicates a workpiece (an object to be processed, for example, a case body of a household electric appliance or the like), numeral 260 indicates a carrier pallet on which the workpiece 295 is loaded, and numeral 262 indicates a roller conveyor for carrying the carrier pallet 260. The cutting device 100 of the present invention is mounted to a robot arm 251 at the tip of the robot 250 as shown in FIG. 1.

When the workpiece 295 loaded on the carrier pallet 260 is placed in front of the cutting device 100, which is detected automatically, the cutting device 100 mounted to the arm of the robot 250 is rotated and driven. Thus, the periphery of the workpiece 295 is cut and processed in a predetermined manner by the five-axes control function (not shown in the figure).

The above-mentioned equipment preferably is provided with the following control device (not shown in the figure). The control device detects at least one of an intrinsic oscillatory waveform and an intrinsic oscillation frequency that are caused by the impact of the impacting bodies against the workpiece 295, a load on driving motors 115, 125 for rotating the rotating units 110, 120 and an outer shape of the workpiece 295 and controls and changes at least one of the rotational speed of each rotating unit (the impact velocity of the impacting bodies), a cutting depth and a relative speed and a relative moving direction (for example, when the cutting is judged to be difficult, the cutting device 100 may be reversed slightly) between the rotating unit and the object to be processed. In this manner, even when the workpiece 295 is formed of a plurality of members with different physical properties, even when the material of the workpiece 295 is unknown, or even when the internal structure of the workpiece 295 that cannot be seen from the outside is unknown, the optimum cutting conditions can be set automatically, thus achieving the automation of the cutting work.

Furthermore, the above-mentioned control device can be provided for each rotating unit. In other words, the control device detects at least one of the intrinsic oscillatory waveform and the intrinsic oscillation frequency that are caused by the impact of the impacting bodies against the workpiece 295, the load on the driving motor for rotating each rotating unit and the outer shape of the workpiece and changes at least one of the rotational speed, the cutting depth and the relative speed and the relative moving direction between the rotating unit and the object to be processed for each of the rotating units. In this manner, it is possible to set an appropriate cutting condition for each rotating unit.

It is needless to say that the conveyor system may be a belt conveyor or a chain conveyor.

Moreover, although FIG. 14 illustrated an example of mounting the cutting device 100 of the first embodiment including the first and second rotating units to one robot, the present invention is not limited thereto. For example, it also is possible to provide a plurality of robots, each of which is provided with one rotating unit, thereby cutting into the workpiece sequentially.

The invention may be embodied in other specific forms without departing from the spirit or essential characteristics thereof. The embodiments disclosed in this application are to be considered in all respects as illustrative and not restrictive, the scope of the invention being indicated by the appended claims rather than by the foregoing description, all changes that come within the meaning and range of equivalency of the claims are intended to be embraced therein.

1. A cutting device comprising:
at least a first rotating unit and a second rotating unit, each of these rotating units comprising;
a rotor with a principal plane,
a spindle provided in a normal direction to the principal plane, and
at least one impacting body mounted on the spindle rotatably,
wherein the impacting body is mounted so that a predetermined fitting gap is provided between the impacting body and the spindle and a part of a periphery of the impacting body can be positioned beyond a periphery of the rotor, and
the impacting body of the first rotating unit and the impacting body of the second rotating unit impact on an object to be processed sequentially while the rotating units are rotated in a plane parallel with the principal plane of the rotor at a high speed and the first and second rotating units are held so that a circular path of a tip of the impacting body of the first rotating unit and a circular path of a tip of the impacting body of the second rotating unit during the rotation substantially are on the same plane, thereby cutting the object to be processed in a direction substantially parallel with the principal plane of the rotor;
wherein a cutting depth by the impacting body of the second rotating unit is larger than that by the impacting body of the first rotating unit, and
the impacting body of at least one of the rotating units impacts on the object to be processed at least at a critical impact velocity.

2. The cutting device according to claim 1, wherein the impacting body of the first rotating unit, which impacts on the object to be processed first, impacts on the object to be processed at least at the critical impact velocity.

3. The cutting device according to claim 1, wherein the rotating units are provided on a common base.

4. The cutting device according to claim 1, wherein an outer shape of the impacting body is any one of a polygon with a plurality of corners, a shape with projections at substantially equal angles on its periphery, a disc shape, a substantially-bell shape, a substantially-“9” shape and a substantially-bow shape.

5. The cutting device according to claim 1, wherein the impacting body for each of the rotating units has a different shape.

6. The cutting device according to claim 1, wherein the fitting gap between the spindle and the impacting body is at least 2 mm.

7. The cutting device according to claim 1, wherein the fitting gap between the spindle and the impacting body is about 5 to 10 mm.

8. The cutting device according to claim 1, wherein the impacting body of at least one of the rotating units impacts on the object to be processed at a speed of at least about 139 m/second (about 500 km/hour).

9. The cutting device according to claim 1, wherein the impacting body of at least one of the rotating units impacts on the object to be processed at a speed of at least about 340 m/second (about 1224 km/hour).

10. The cutting device according to claim 1, wherein the impacting body of at least one of the rotating units impacts on the object to be processed at a speed at least twice as high as the critical impact velocity of the object to be processed.

11. The cutting device according to claim 1, wherein the impacting body that impacts on the object to be processed at least at the critical impact velocity cuts the object to be processed by impacting on the object to be processed to smash a surface thereof.

12. The cutting device according to claim 1, mounted to an arm of a robot with a multi-axis control function.

13. The cutting device according to claim 1, wherein at least one of an intrinsic oscillatory waveform and an intrinsic oscillation frequency that are caused by an impact of the impacting body against the object to be processed, a load on a driving motor for rotating each of the rotating units and an outer shape of the object to be processed is detected, and at least one of a rotational speed of the rotating units, a cutting depth and a relative speed and a relative moving direction between the rotating units-and the object to be processed is changed.

14. The cutting device according to claim 13, wherein at least one of the intrinsic oscillatory waveform, the intrinsic oscillation frequency and the load on the driving motor is detected for each of the rotating units, and at least one of the rotational speed of the rotating units, the cutting depth and the relative speed and the relative moving direction between the rotating units and the object to be processed is changed for each of the rotating units.

15. A cutting method comprising:
using at least a first rotating unit and a second rotating unit, each of these rotating units comprising;
a rotor with a principal plane,
a spindle provided in a normal direction to the principal plane, and
at least one impacting body mounted on the spindle rotatably; and
allowing the impacting body of the first rotating unit and the impacting body of the second rotating unit to impact on an object to be processed sequentially while the rotating units are rotated in a plane parallel with the principal plane of the rotor at a high speed and the first and second rotating units are held so that a circular path of a tip of the impacting body of the first rotating unit and a circular path of a tip of the impacting body of the second rotating unit during the rotation substantially are on the same plane, thereby cutting the object to be processed in a direction substantially parallel with the principal plane of the rotor;
wherein the impacting body of each of the rotating units is mounted so that a predetermined fitting gap is provided between the impacting body and the spindle and a part of a periphery of the impacting body can be positioned beyond a periphery of the rotor,
a cutting depth by the impacting body of the second rotating unit is made larger than that by the impacting body of the first rotating unit, and
the impacting body of at least one of the rotating units is allowed to impact on the object to be processed at least at a critical impact velocity.

16. The cutting method according to claim 15, wherein, when the object to be processed is formed by layering at least a first layer and a second layer that have different critical impact velocities, the first layer is cut mainly by the impacting body of the first rotating unit, the second layer is cut mainly by the impacting body of the second rotating unit, and an impact velocity of the impacting body of the first rotating unit against the object to be processed is made different from that of the impacting body of the second rotating unit against the object to be processed.

17. The cutting method according to claim 15, wherein, when the object to be processed is formed by layering at least a first layer and a second layer that has a critical impact velocity smaller than the first layer, the first layer is cut mainly by the impacting body of the first rotating unit, and the second layer is cut mainly by the impacting body of the second rotating unit.

18. The cutting method according to claim 17, wherein the cutting depth by the impacting body of the first rotating unit is equal to or larger than a thickness of the first layer.

19. The cutting method according to claim 17, wherein the impacting body of the first rotating unit is allowed to impact on the first layer at least at the critical impact velocity of the first layer.

20. The cutting method according to claim 17, wherein the impacting body of the first rotating unit is allowed to impact on the first layer at a speed at least twice as high as the critical impact velocity of the first layer.

21. The cutting method according to claim 17, wherein the impacting body of the first rotating unit is allowed to impact on the first layer at a speed of at least about 139 m/second (about 500 km/hour).

22. The cutting method according to claim 17, wherein the impacting body of the first rotating unit is allowed to impact on the first layer at a speed of at least about 340 m/second (about 1224 km/hour).

23. The cutting method according to claim 17, wherein the impacting body of the second rotating unit is allowed to impact on the second layer at a speed not greater than the critical impact velocity of the first layer.

24. The cutting method according to claim 15, wherein the circular path of the tip of the impacting body of the first rotating unit has a smaller radius than the circular path of the tip of the impacting body of the second rotating unit.
